(19) United States
(12) Patent Application Publication
(10) Pub. No.: US 2024/0094476 A1
(43) Pub. Date: Mar. 21, 2024

(54) TECHNOLOGIES FOR A PLUGGABLE OPTICAL CONNECTOR

(71) Applicant: Intel Corporation, Santa Clara, CA (US)

(72) Inventors: Wesley B. Morgan, Lake Oswego, OR (US); David Shia, Portland, OR (US); Mohanraj Prabhugoud, Beaverton, OR (US); Eric J. M. Moret, Beaverton, OR (US); Pooya Tadayon, Portland, OR (US)

(73) Assignee: Intel Corporation, Santa Clara, CA (US)

(21) Appl. No.: 17/949,417

(22) Filed: Sep. 21, 2022

(51) Int. Cl. G02B 6/38

(52) U.S. Cl. CPC G02B 6/3871; G02B 6/3873; G02B 6/3887

(57) ABSTRACT

Technologies for pluggable optical connectors are disclosed. In the illustrative embodiment, an optical plug includes a ferrule with one or more optical fibers. The optical plug also includes a ferrule holder that holds the ferrule and a housing that encloses the ferrule and ferrule holder. The ferrule holder can move relative to the house, and the ferrule can move relative to the ferrule holder and the housing. As the optical plug is plugged into a socket, alignment features in the housing coarsely align the ferrule. Intermediate alignment features in the ferrule holder then engage, aligning the ferrule more precisely. As the optical plug is fully plugged in, fine alignment features in the ferrule engage, precisely aligning the ferrule and the optical fibers with the optical socket.

### BACKGROUND

Photonic integrated circuits (PICs) can be used for several applications, such as communications. Efficiently and cheaply aligning optics to couple light into and out of PICs can be a challenge. Approaches such as attachment of optical fiber arrays to PICs may be slow, incompatible with conventional semiconductor packaging processes, and can result in substantial yield and throughput issues.

### BRIEF DESCRIPTION OF THE DRAWINGS

FIG. 1 is a simplified drawing of one embodiment of a connectorized optical cable with an optical plug.

FIG. 2 is a simplified drawing of one embodiment of the connectorized optical cable of FIG. 1 that has been disassembled.

FIG. 3 is a simplified drawing of one embodiment of a system with a connectorized optical cable with an optical plug and an integrated circuit package.

FIG. 4 is a simplified drawing of one embodiment of a spring clip of an optical plug.

FIG. 5 is a cross-sectional view of one embodiment of a system with a connectorized optical cable mated with an optical socket.

FIG. 6 is a simplified drawing of one embodiment of a system with a connectorized optical cables being plugged into optical sockets.

FIG. 7 is a cross-sectional view of one embodiment of a system with a connectorized optical cable mated with an optical socket.

FIG. 8 is a cross-sectional view of one embodiment of an optical plug.

FIG. 9 is a simplified drawing of components of one embodiment of parts of an optical plug and an optical socket.

FIG. 10 is a simplified drawing of one embodiment of a connectorized optical cable with an optical plug.

FIG. 11 is a simplified drawing of one embodiment of a connectorized optical cable with an optical plug.

FIG. 12 is a simplified drawing of one embodiment of a system with a connectorized optical cable with an optical plug and an integrated circuit package.

FIG. 13 is a simplified drawing of one embodiment of a system with a connectorized optical cable with an optical plug and an integrated circuit package.

FIG. 14 is a simplified flow diagram of at least one embodiment of a method for manufacturing a system including a connectorized optical cable with an optical plug and an integrated circuit package.

FIG. 15 is a top view of a wafer and dies that may be included in a microelectronic assembly, in accordance with any of the embodiments disclosed herein.

FIG. 16 is a cross-sectional side view of an integrated circuit device that may be included in a microelectronic assembly, in accordance with any of the embodiments disclosed herein.

FIGS. 17A-17D are perspective views of example planar, gate-all-around, and stacked gate-all-around transistors.

FIG. 18 is a cross-sectional side view of an integrated circuit device assembly that may include a microelectronic assembly, in accordance with any of the embodiments disclosed herein.

FIG. 19 is a block diagram of an example electrical device that may include a microelectronic assembly, in accordance with any of the embodiments disclosed herein.

### DETAILED DESCRIPTION

In various embodiments disclosed herein, a connectorized optical cable with an optical plug can plug into an optical socket of an integrated circuit package. The optical plug includes a ferrule with alignment features that allow it to be precisely aligned with fibers or waveguides in an optical socket (e.g., with sub-micron precision). In order for the ferrule to be coarsely aligned with an optical socket, in the illustrative embodiment, a ferrule holder with intermediate alignment features loosely holds the ferrule, and a housing with coarse alignment features loosely holds the ferrule holder. In use, as the optical plug is plugged into an optical socket, the housing coarsely aligns the ferrule holder. The ferrule holder, in turn, aligns the ferrule with intermediate precision. Finally, the alignment features on the ferrule are used to finely align the optical fibers of the plug with fibers or waveguides in a socket.

In the illustrative embodiment, the optical plug provides several advantages. It can be relatively low profile, allowing for smaller packages. The optical plug can be plugged into a photonic integrated circuit (PIC) component, eliminating the need for a potentially low-yield process to couple the PIC die to optical fibers. The retention mechanism (described below) can be user-friendly. A strain relief can provide for connection robustness under inadvertent pulling on the optical cable.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicates via an embedded bridge in a package substrate and an integrated circuit package attached to a printed circuit board that send signals to or receives signals from other integrated circuit packages or electronic devices attached to the printed circuit board.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “various embodiments,” “some embodiments,” and the like may include features, structures, or characteristics, but not every embodiment necessarily includes the particular features, structures, or characteristics.

Some embodiments may have some, all, or none of the features described for other embodiments. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term. For example, the central axis of a magnetic plug that is substantially coaxially aligned with a through hole may be misaligned from a central axis of the through hole by several degrees. In another example, a substrate assembly feature, such as a through width, that is described as having substantially a listed dimension can vary within a few percent of the listed dimension.

It will be understood that in the examples shown and described further below, the figures may not be drawn to scale and may not include all possible layers and/or circuit components. In addition, it will be understood that although certain figures illustrate transistor designs with source/drain regions, electrodes, etc. having orthogonal (e.g., perpendicular) boundaries, embodiments herein may implement such boundaries in a substantially orthogonal manner (e.g., within +/−5 or 10 degrees of orthogonality) due to fabrication methods used to create such devices or for other reasons.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “located on” in the context of a first layer or component located on a second layer or component refers to the first layer or component being directly physically attached to the second part or component (no layers or components between the first and second layers or components) or physically attached to the second layer or component with one or more intervening layers or components.

As used herein, the term “adjacent” refers to layers or components that are in physical contact with each other. That is, there is no layer or component between the stated adjacent layers or components. For example, a layer X that is adjacent to a layer Y refers to a layer that is in physical contact with layer Y.

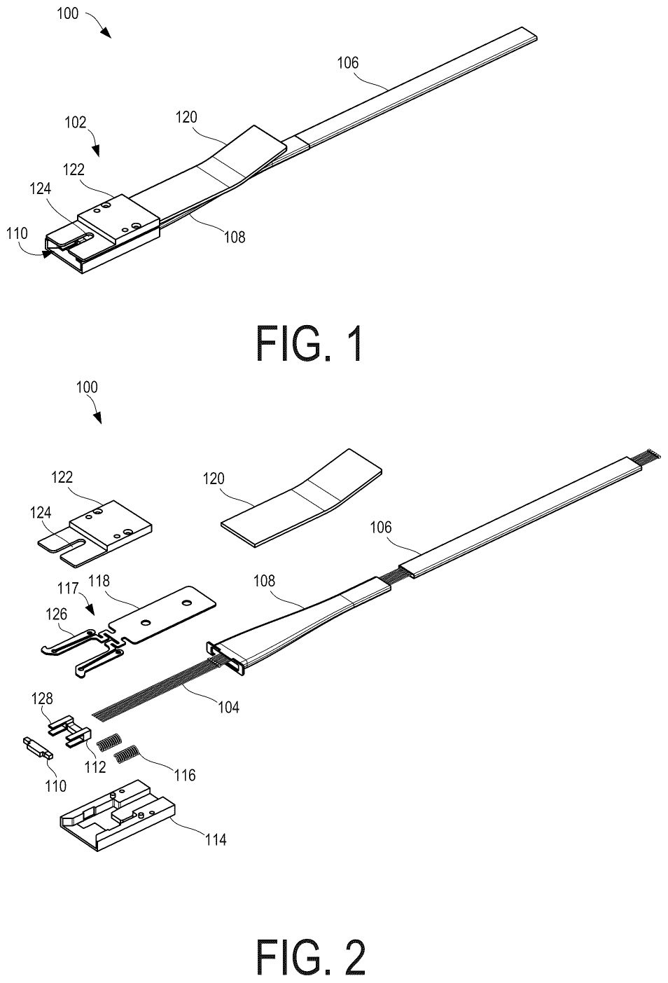

Referring now to FIGS. 1 and 2, in one embodiment, an optical cable 100 includes one or more optical fibers 104 in a sheath 106 connected to an optical plug 102. FIG. 1 shows an assembled optical cable 100, and FIG. 2 shows a disassembled optical cable 100, showing several of the parts of the optical cable. A strain relief 108 is positioned between the sheath 106 and the optical plug 102. In the illustrative embodiment, the optical fibers 104 are free to move inside the strain relief 108, providing some slack in the optical fibers 104 and allowing the ferrule 110 to move relative to the strain relief 108. When assembled, the optical fibers 104 extend through the ferrule 110, terminating at an end face of the ferrule 110. A ferrule holder 112 holds the ferrule 110 loosely in place. Housing 114 holds the ferrule 110 and the ferrule holder 112. A housing cover 122 keeps the ferrule 110 and ferrule holder 112 within the housing 114. In the illustrative embodiment, springs 116 apply a force on the ferrule holder 112 and the ferrule 110. In use, as the plug 102 is mated with an optical socket, the springs 116 apply a force on the ferrule 110, pressing it against the optical socket, ensuring the ferrule 110 is in contact with the optical socket.

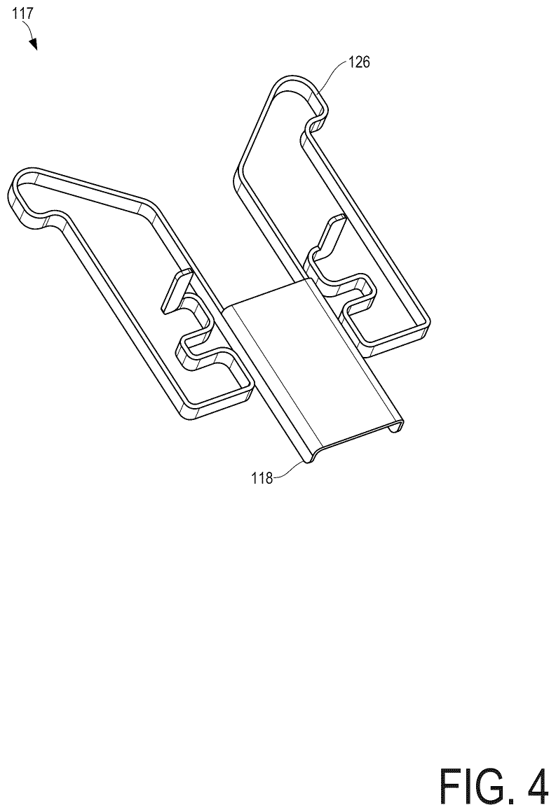

Retention mechanism 117 is also positioned inside of the housing 114. As the plug 102 is plugged into a socket, a spring clip 126 engages with part of the socket, securing the optical plug 102 in place. Pulling on tab 118 of the retention mechanism 117 will pull part of the spring clip 126 inward, freeing the plug 102 from the socket. Tab cover 120 can be attached to the tab 118 to allow a user to pull on the retention mechanism 117 more easily. In some embodiments, the retention mechanism 117 may press the ferrule 110 against the optical socket instead of or in addition to the springs 116. A larger view of one embodiment of such a retention mechanism 117 is shown in FIG. 4.

The housing cover 122 includes a slot 124, which can be used to both coarsely align the plug 102 as well as act as an orientation key, preventing the optical plug 102 from being inserted upside down. In addition to or as an alternative to the housing cover, in some embodiments, the optical plug 102 may include a sleeve surrounding the housing 114. The sleeve may contain the components of the optical plug 102 while allowing for servicing by removal of the sleeve.

It should be appreciated that the ferrule holder 112 and the ferrule 110 can move within the housing 114 and that the ferrule 110 can move within the ferrule holder 112. As such, as the plug 102 is inserted into a socket, the ferrule holder 112 can move relative to the housing 114 to more precisely align the ferrule holder 112, and then the ferrule 110 can move relative to the ferrule holder 112 to more precisely align the ferrule 110. The ferrule holder 112 may be aligned using alignment features 128. The housing 114, the ferrule holder 112, and the ferrule 110 provide multi-stage alignment.

The optical cable 100 may include any suitable number of optical fibers, such as 1-32 fibers. The optical fibers 104 may be arranged at the ferrule 110 in a one- or two-dimensional array. The illustrative optical fibers 104 are made out of glass and can carry light at any suitable wavelength, such as 400-2,000 nanometers. In the illustrative embodiment, the optical fibers 104 may support light in the C-band, O-band, L-band, S-band, etc. In other embodiments, the optical fibers 104 may be made out of a different material.

The ferrule 110 may be made of any suitable material, such as glass or ceramic. In some embodiments, the ferrule 110 may be formed using laser machining. The ferrule 110 may include one or more alignment features that align the ferrule 110 precisely with an optical socket. For example, the alignment features on the ferrule 110 may align the ferrule 110 to within less than one micrometer.

The optical plug 102 may have any suitable dimensions. In the illustrative embodiment, the optical plug 102 has a width of about 5 millimeters and a height of about 1.5 millimeters. In other embodiments, the optical plug 102 may have a height and/or width of, e.g., 1-10 millimeters.

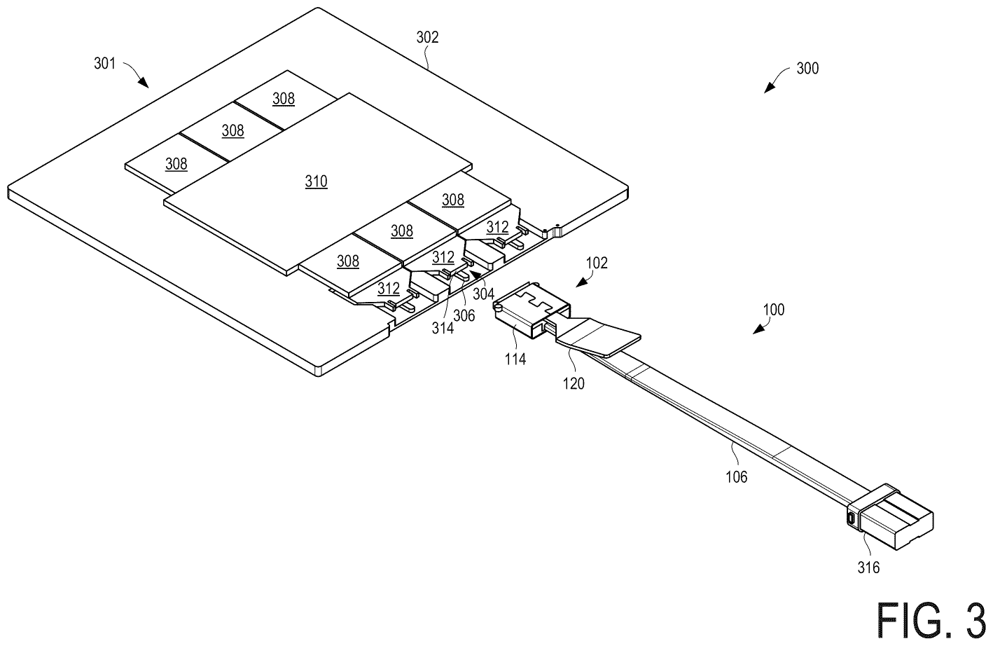

Referring now to FIG. 3, in one embodiment, a system 300 includes an integrated circuit package 301 and an optical cable 100 with an optical plug 102. In the illustrative embodiment, sockets 304 are formed from a substrate 302 and an optical coupler interposer 312. A rib 306 in the socket 304 corresponds to the slot 124 in the optical plug 102, aligning the housing 114 to the socket 304. The interposer 312 has a face 314 in which the ends of one or more waveguides are positioned. When the optical plug 102 is mated with the optical socket 304, the optical fibers 104 of the optical plug 102 are lined up with the waveguides in the interposer 312 to within, e.g., less than one micrometer. The optical cable 100 may have an optical plug 316 on the opposite end, which may be similar to, the same as, or different from the optical plug 102.

The substrate 302 may support several integrated circuit dies, such as one or more photonic integrated circuit (PIC) dies 308 and one or more electrical integrated circuit (EIC) dies 310. In the illustrative embodiment, waveguides in the interposer 312 can carry light between the optical fibers 104 of the optical plug 102 and the PIC dies 308.

The illustrative substrate 302 may be any suitable substrate, such as glass, silicon, ceramic, a circuit board, etc. In some embodiments, the substrate 302 is a circuit board made from any suitable material, such as ceramic, glass, and/or organic-based materials with fiberglass and resin, such as FR-4. The substrate 302 may have any suitable length or width, such as 10-500 millimeters. The substrate 302 may have any suitable thickness, such as 0.2-5 millimeters. The substrate 302 may support additional components besides those shown in FIG. 3, such as resistors, capacitors, other integrated circuit dies, power electronics, traces, etc. In the illustrative embodiment, part of the socket 304, such as the rib 306, the frame of the socket, etc., is formed in the substrate 302.

The illustrative interposer 312 is silicon oxide glass. In other embodiments, the interposer 312 may be made of any suitable crystalline or non-crystalline material, such as fused silicon, borosilicate, sapphire, yttrium aluminum garnet, etc. The interposer 312 may have any suitable length or width, such as 10-500 millimeters. The interposer 312 may have any suitable thickness, such as 0.2-5 millimeters.

The interposer 312 may route light between the optical plug 102 and the PIC dies 308 using waveguides defined in the interposer 312. The waveguides may be routed in any suitable manner, including in three dimensions, allowing for flexible layouts. The interposer 312 may include optical elements such as fan outs, splitters, couplers, combiners, filters, etc.

The PIC die 308 may be made of any suitable material, such as silicon. In the illustrative embodiment, waveguides are defined in the PIC die 308 that interface with waveguides defined in the interposer 312 to transfer light to or from the PIC die 308. In an illustrative embodiment, waveguides in the PIC die 308 may be silicon waveguides embedded in silicon oxide cladding. The PIC dies 308 may include any suitable number of waveguides, such as 1-1,024.

The PIC die 308 is configured to generate, detect, and/or manipulate light. The PIC die 308 may include active or passive optical elements such as splitters, couplers, filters, optical amplifiers, lasers, photodetectors, modulators, etc. The PIC die 308 may have electrical connections to the substrate 302 and/or the EIC die 310, such as for power delivery, sending and receiving data, and/or the like.

The EIC die 310 may include any suitable electronic integrated circuit package, such as resistors, capacitors, inductors, transistors, etc. The EIC die 310 may include any suitable analog and/or digital circuitry, such as a processor, a memory, an application-specific integrated circuit (ASIC), a field-programmable gate array (FPGA), etc. In some embodiments, the system 300 may be embodied as a router, a switch, a network interface controller, and/or the like. In such embodiments, the EIC die 310 may include network interface controller circuitry to process, parse, route, etc., network packets sent and received by the system 300 through the optical cable 100.

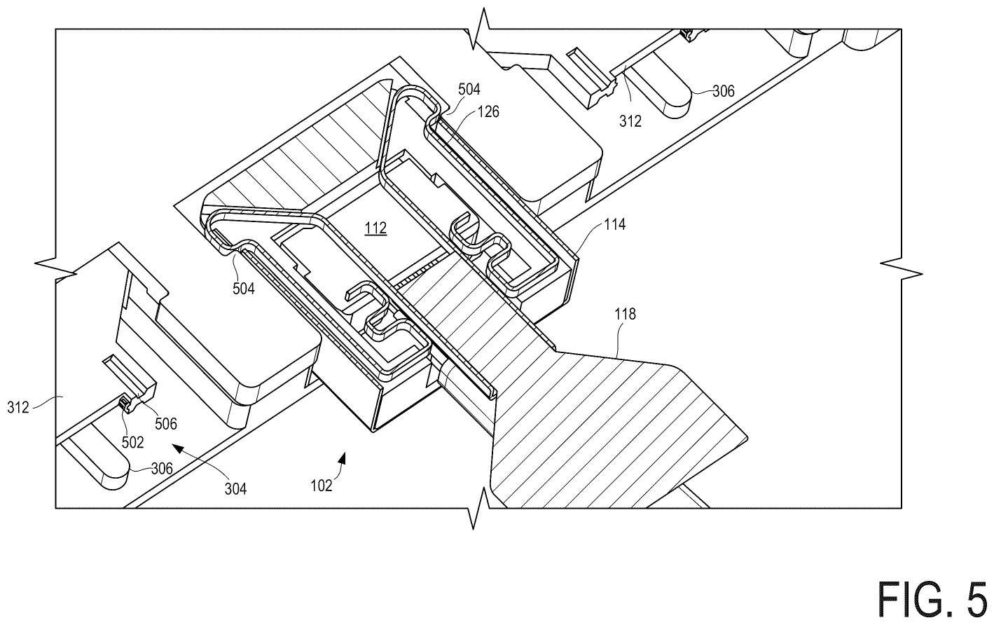

Referring now to FIG. 5, in one embodiment, a zoomed-in view of an optical plug 102 mated with an optical socket 304 is shown, with a cross-section taken of the optical plug 102 to show components under the housing 114. As shown in the figure, the protrusions of the spring clip 126 mate with ridges 504, retaining the optical plug 102. When the tab 118 is pulled, the protrusions of the spring clip 126 are pulled inward, freeing the optical plug 102. Intermediate-precision alignment features 506 and fine-precision alignment features 502 on the interposer 312 are visible in FIG. 5. The intermediate-precision alignment features 506 are used to align the ferrule holder 112, and the fine-precision alignment features 502 are used to align the ferrule 110 to the interposer 312.

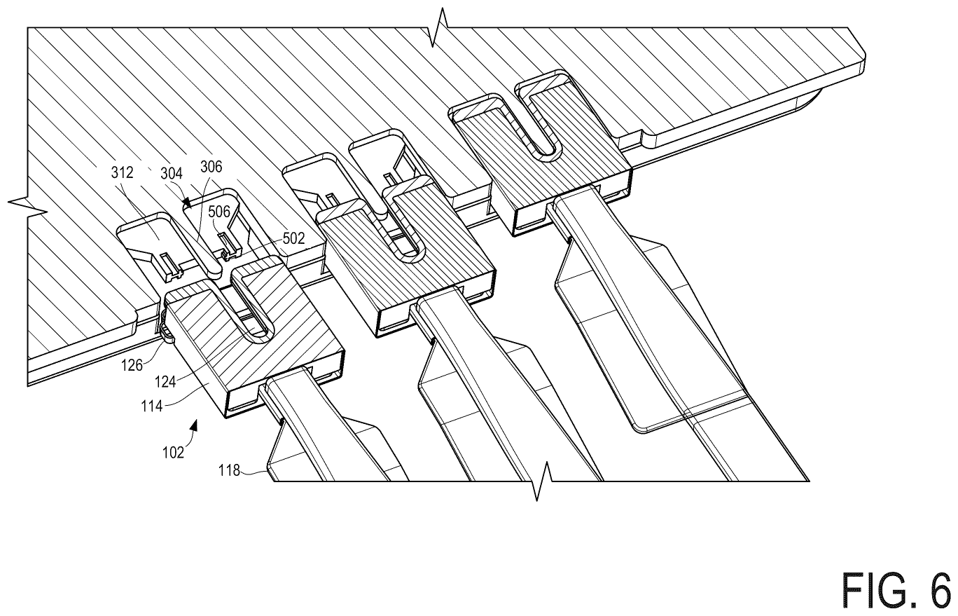

Referring now to FIG. 6, in one embodiment, an optical plug 102 is shown at different stages of being mated with an optical socket 304. As the optical plug 102 engages with the socket 304, the housing 114 is lined up with the frame of the socket 304. The protrusions of the spring clip 126 are automatically pressed inward by the frame of the socket 304. The rib 306 aligns with the slot 124 as the optical plug 102 is inserted into the socket 304. It should be appreciated that, as the optical plug 102 is inserted into the socket 304, the housing 114 lining up with the frame of the socket 304 as well as the rib 306 lining up with the slot 124 coarsely align the optical plug 102 with the optical socket 304.

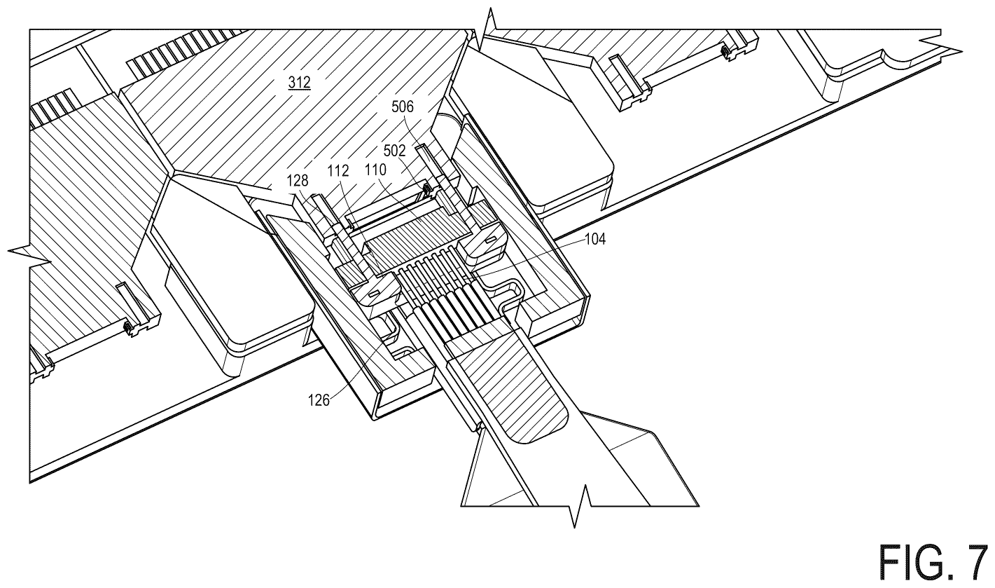

Referring now to FIG. 7, in one embodiment, a cross-section of an optical plug 102 is shown as it is being inserted into an optical socket 304. In particular, FIG. 7 shows the alignment features 128 of the ferrule holder 112 as they engage with the intermediate alignment features 506 of the interposer 312. The mating of the intermediate alignment features 128 of the ferrule holder 112 with the intermediate alignment features 506 of the interposer 312 more precisely aligns the ferrule 110 with the interposer 312 as the optical plug is inserted into the optical socket 304.

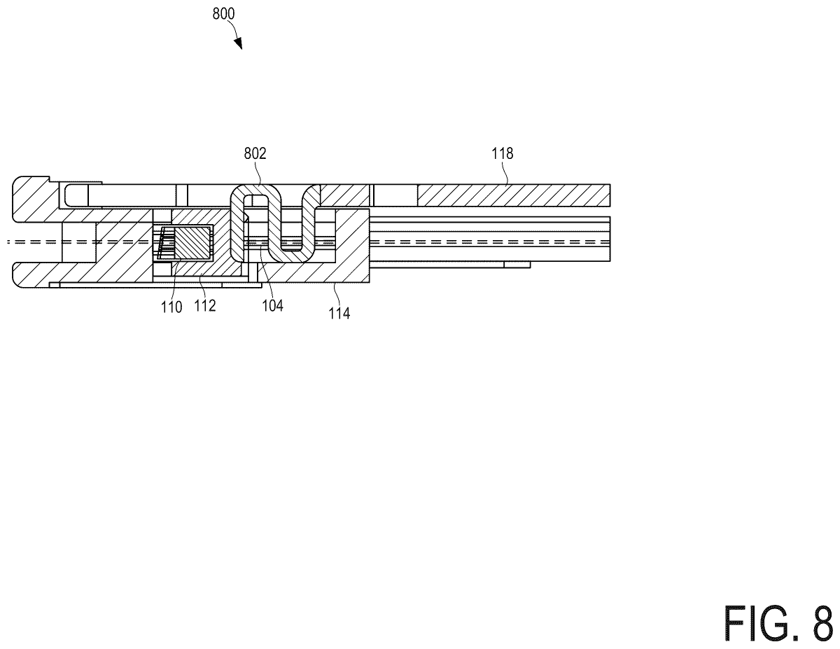

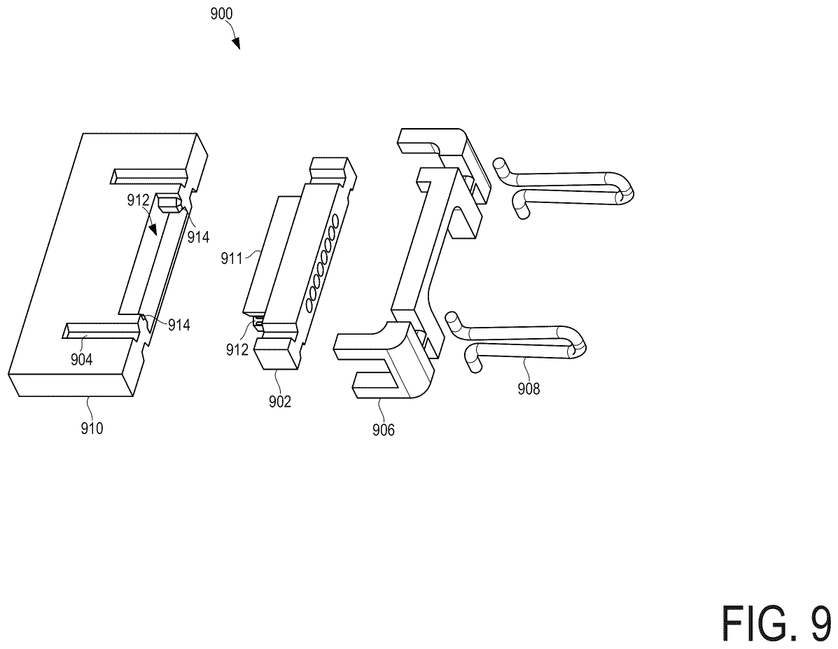

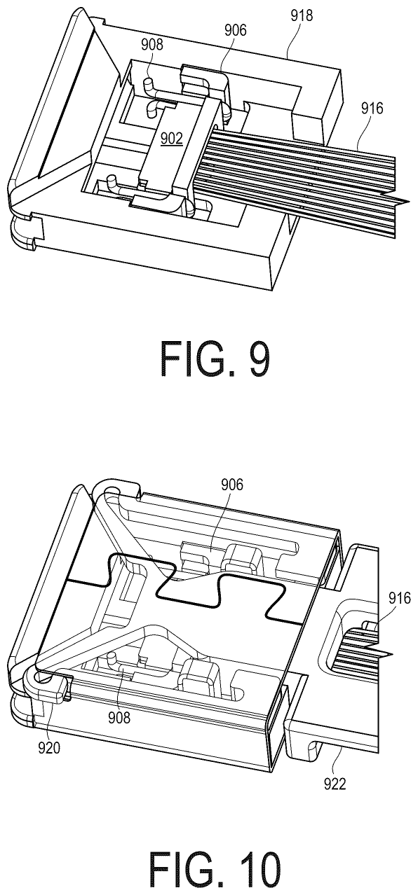

It should be appreciated that the optical plug 102 and optical socket 304 described above is merely one possible embodiment, and other embodiments are envisioned as well. For example, FIG. 8 shows an optical plug 800 with a spring 802 pressing on the ferrule holder 112. The spring 802 will limit and control the amount of force applied to the ferrule 110 towards the interposer. As another example, FIG. 9 shows a system 900 with one embodiment of parts of an optical plug and an optical socket. The optical plug includes a ferrule 902 and ferrule holder 906. The optical plug also includes clips 908, which act as intermediate alignment features, similar to the alignment features 128 of the ferrule holder 112. When the optical plug is mated with the optical socket, the clips 908 interface with alignment slots 904 of the interposer 910 of the optical socket. FIG. 9 also shows fine alignment features of the ferrule 902 and the interposer 910. The optical ferrule 902 may have a protrusion feature 911 to mate with a corresponding cut-out 912 in the interposer 910, with a cut-out 912 on the sidewall of the protrusion feature 911. The corresponding interposer 910 may have a cut-out 912 to mate with the protrusion features 911 and protrusion features 914 on the sidewall to match the cut-out 912 of the ferrule 902. FIGS. 10 and 11 show the assembled optical plug, including optical fibers 916, spring clip 920, pull tab 922, etc.

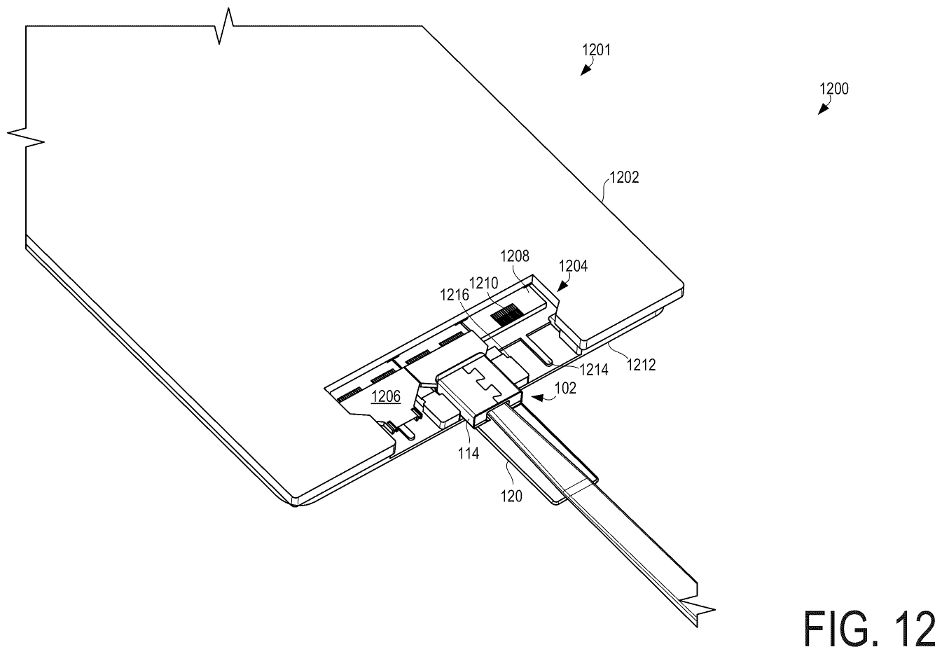

In addition to different embodiments of the optical plug, different embodiments for an optical socket are envisioned as well. For example, FIG. 12 shows an embodiment of a system 1200 with an integrated circuit package 1201 that includes an optical socket 1204 mated with an optical plug 102. The integrated circuit package 1201 includes a substrate 1202, one or more PIC dies 1208, and an integrated heat spreader 1212 that covers the PIC dies 1208. The interposer 1206 can transfer light between the optical plug 102 and waveguides 1210 defined in the PIC dies 1208. The integrated circuit package 1201 may also include one or more EIC dies, similar to the integrated circuit package 301 described above. Part of the optical socket 1204 may be formed from the integrated heat spreader 1212. For example, the rib 1214 to align with the slot 124 may be part of the integrated heat spreader, as may the ridges 1216 that interface with protrusions of the spring clip 126.

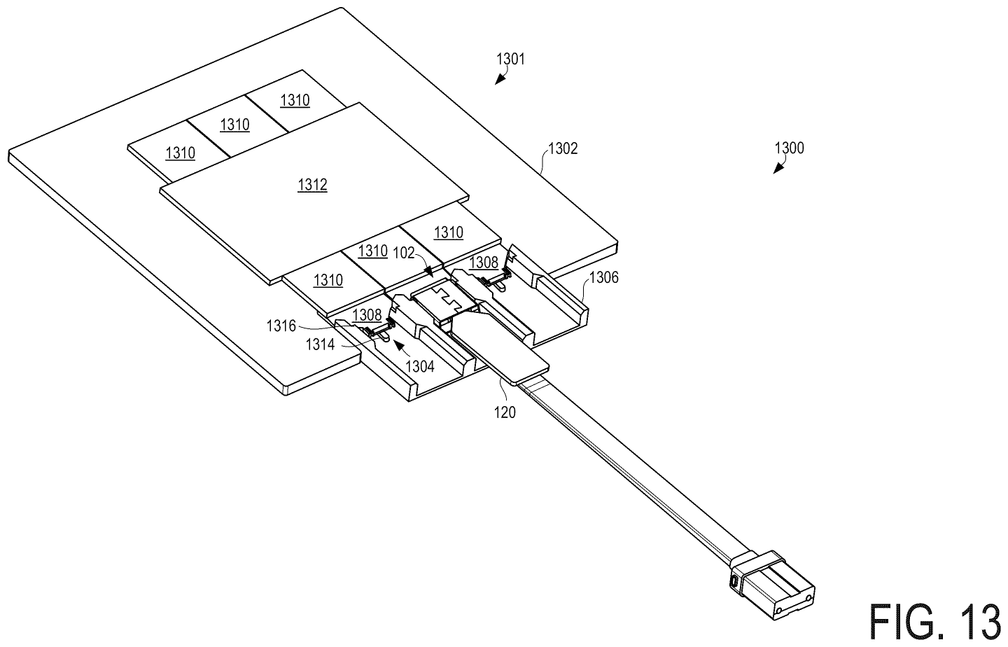

In another example, FIG. 13 shows an embodiment of a system 1300 with an integrated circuit package 1301 that includes an optical socket 1304 mated with an optical plug 102. The integrated circuit package 1301 includes a substrate 1302, one or more PIC dies 1310, and an EIC die 1312. An interposer 1308 can transfer light between the optical plug 102 and the PIC die 1310. The integrated circuit package 1301 also includes a receptacle component 1306 that is attached to the substrate 1302. The receptacle component 1306 includes a rib 1314 to align with the slot 124 as well as ridges 1316 that interface with protrusions of the spring clip 126.

In addition to the examples described above, other embodiments are envisioned as well. For example, the retention mechanism 117 with the spring clip 126 and the pull tab 118 may include the slot 124. The retention mechanism 117 may be above or below the ferrule 110. In some embodiments, the housing 114 may provide coarse alignment, and the ferrule 110 may provide fine alignment, without a ferrule holder 112 or other component providing an intermediate level of alignment. In the illustrative embodiment, the ferrule 110 holds one or more optical fibers. In other embodiments, the ferrule 110 may support components for expanded beam coupling.

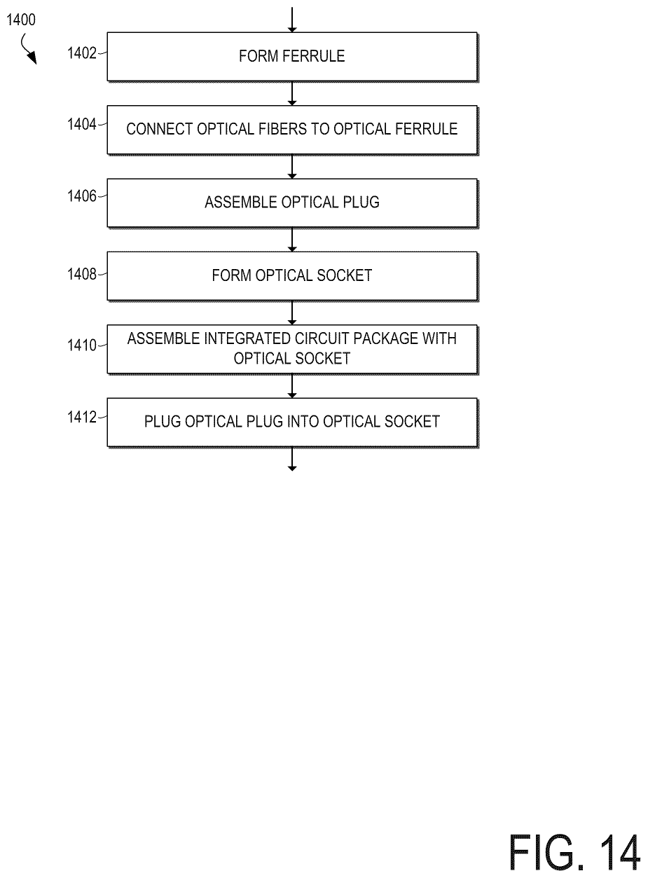

Referring now to FIG. 14, in one embodiment, a flowchart for a method 1400 for creating a system with an optical cable and an integrated circuit package with an optical socket that mates with an optical plug of the optical cable. The method 1400 may be executed by a technician and/or by one or more automated machines. In some embodiments, one or more machines may be programmed to do some or all of the steps of the method 1400. Such a machine may include, e.g., a memory, a processor, data storage, etc. The memory and/or data storage may store instructions that, when executed by the machine, causes the machine to perform some or all of the steps of the method 1400. The method 1400 may use any suitable set of techniques that are used in semiconductor processing, such as chemical vapor deposition, atomic layer deposition, physical layer deposition, molecular beam epitaxy, layer transfer, photolithography, ion implantation, dry etching, wet etching, selective laser etching, thermal treatments, flip chip, layer transfer, magnetron sputter deposition, pulsed laser deposition, laser machining, etc. It should be appreciated that the method 1400 is merely one embodiment of a method to create one embodiment of a system (such as the system 300, the system 1200, the system 1300, etc.) and other methods may be used to create any suitable embodiment of the system. In some embodiments, steps of the method 1400 may be performed in a different order than that shown in the flowchart.

The method 1400 begins in block 1402, in which an ferrule 110 with alignment features is formed. The ferrule 110 may be formed in any suitable manner, such as by using laser machining. The ferrule 110 may include any suitable alignment features, such as pins that mate with corresponding holes in an interposer as well as a protrusion features to mate with a corresponding cut-out in the interposer. In some embodiments, the holes in the interpose may be replaced with V-grooves. In another embodiment, the optical ferrule may have a protrusion features to mate with a corresponding cut-out in the interposer, with a cut-out on the sidewall of the protrusion feature, as shown in FIG. 9. The corresponding interposer may have a cut-out to mate with the protrusion features and protrusion features on the sidewall to match the cut-out of the ferrule. The shape of the protrusion features and cut-outs on the side walls may be any suitable shape, such as a half-cylinder, a triangle, an inverted triangle with ball-like protrusions, and/or the like. In some embodiments, the protrusion of the optical ferrule and the corresponding cut-out in the interpose may have chamfered corners, which can act as a final alignment feature. In some embodiments, the protrusions and/or cut-outs in the sidewalls may have chamfered edges that generate self-centering forces to push the ferrule relative to the interposer.

In block 1404, one or more optical fibers are connected to the optical ferrule. In block 1406, the optical plug is assembled. The optical plug may include the optical ferrule, a ferrule holder, one or more springs to press the ferrule against the interposer, a retention mechanism with a spring clip and pull tab, etc.

In block 1408, an optical socket is formed from an interposer and other components. A frame of the socket may be formed by, e.g., a substrate, a circuit board, an integrated heat spreader, a receptacle component (e.g., the receptacle component 1406 described above), etc. The interposer may have one or more waveguides defined within it to transfer light between the optical plug and a PIC die. The interpose may include the alignment features corresponding to the alignment features of the optical ferrule described above.

In block 1410, an integrated circuit package is assembled with the optical socket. The integrated circuit package may include one or more EIC dies, one or more PIC dies, the interposer, etc. In block 1412, the optical plug is plugged into the optical socket, optically coupling the one or more optical fibers in the plug to the one or more waveguides in the interposer. It should be appreciated that the optical plug can be freely inserted or removed after assembly of the integrated circuit package.

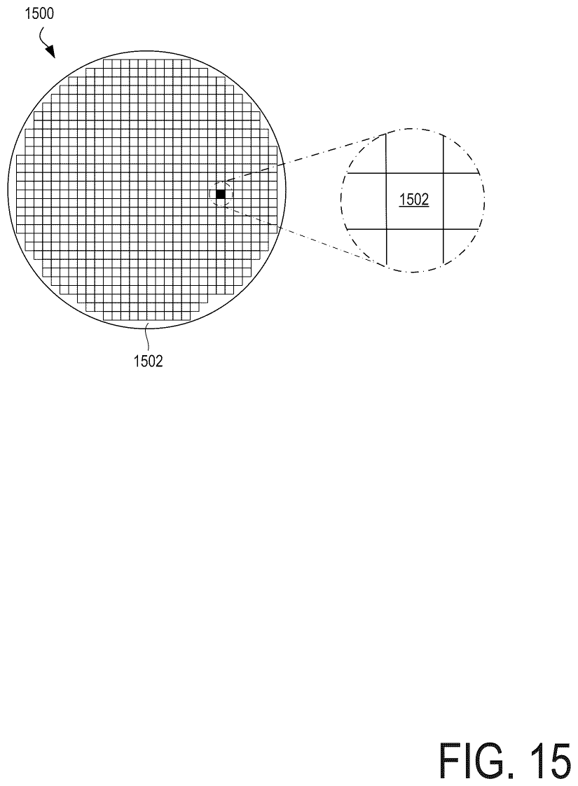

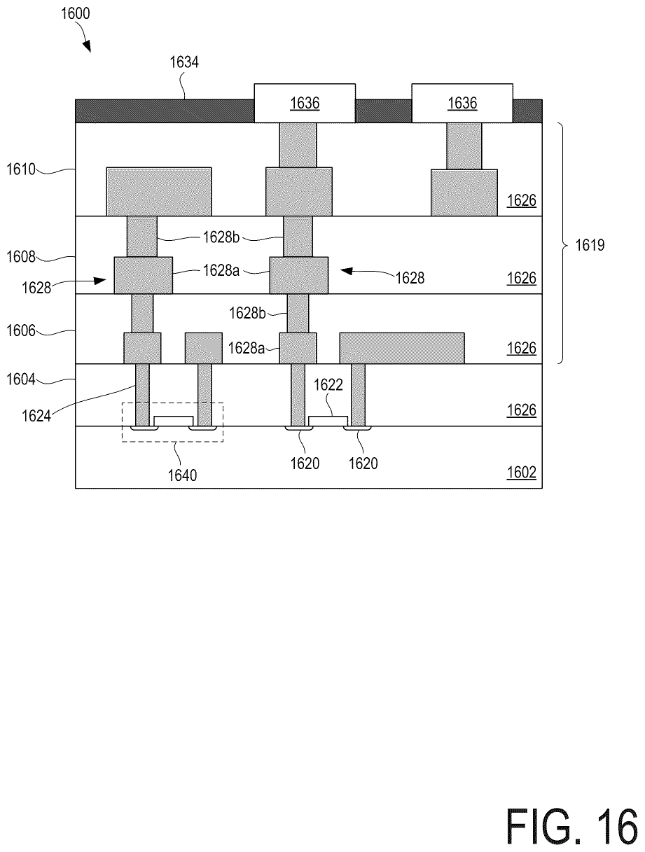

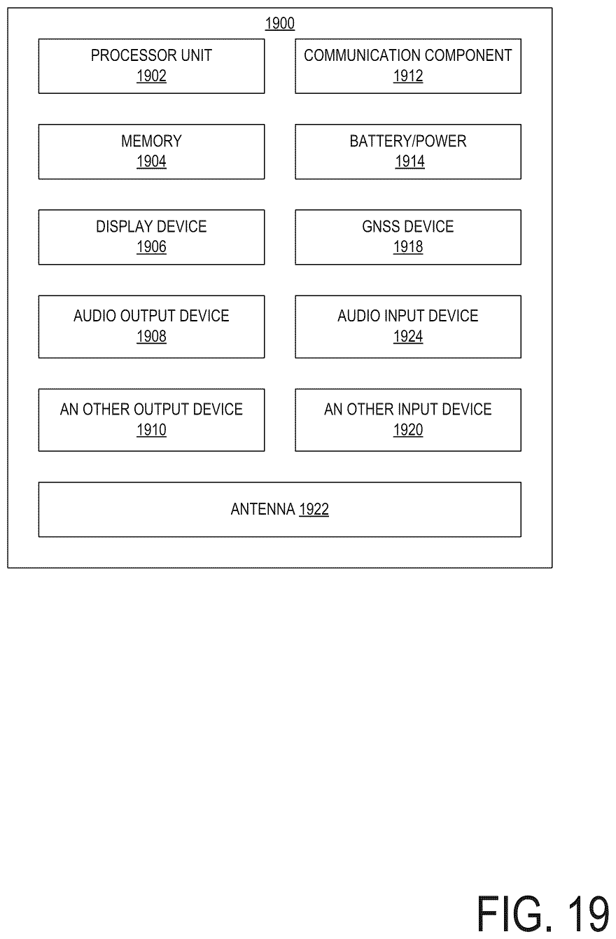

FIG. 15 is a top view of a wafer 1500 and dies 1502 that may be included in any of the integrated circuit packages 301 disclosed herein (e.g., as any suitable ones of the dies 308, 310). The wafer 1500 may be composed of semiconductor material and may include one or more dies 1502 having integrated circuit structures formed on a surface of the wafer 1500. The individual dies 1502 may be a repeating unit of an integrated circuit product that includes any suitable integrated circuit. After the fabrication of the semiconductor product is complete, the wafer 1500 may undergo a singulation process in which the dies 1502 are separated from one another to provide discrete “chips” of the integrated circuit product. The die 1502 may be any of the dies 308, 310 disclosed herein. The die 1502 may include one or more transistors (e.g., some of the transistors 1640 of FIG. 16, discussed below), supporting circuitry to route electrical signals to the transistors, passive components (e.g., signal traces, resistors, capacitors, or inductors), and/or any other integrated circuit components. In some embodiments, the wafer 1500 or the die 1502 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1502. For example, a memory array formed by multiple memory devices may be formed on a same die 1502 as a processor unit (e.g., the processor unit 1902 of FIG. 19) or other logic that is configured to store information in the memory devices or execute instructions stored in the memory array. Various ones of the integrated circuit packages 301 disclosed herein may be manufactured using a die-to-wafer assembly technique in which some dies 308, 310 are attached to a wafer 1500 that include others of the 308, 310, and the wafer 1500 is subsequently singulated.

FIG. 16 is a cross-sectional side view of an integrated circuit device 1600 that may be included in any of the integrated circuit packages 301 disclosed herein (e.g., in any of the dies 308, 310). One or more of the integrated circuit devices 1600 may be included in one or more dies 1502 (FIG. 15). The integrated circuit device 1600 may be formed on a die substrate 1602 (e.g., the wafer 1500 of FIG. 15) and may be included in a die (e.g., the die 1502 of FIG. 15). The die substrate 1602 may be a semiconductor substrate composed of semiconductor material systems including, for example, n-type or p-type materials systems (or a combination of both). The die substrate 1602 may include, for example, a crystalline substrate formed using a bulk silicon or a silicon-on-insulator (SOI) substructure. In some embodiments, the die substrate 1602 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1602. Although a few examples of materials from which the die substrate 1602 may be formed are described here, any material that may serve as a foundation for an integrated circuit device 1600 may be used. The die substrate 1602 may be part of a singulated die (e.g., the dies 1502 of FIG. 15) or a wafer (e.g., the wafer 1500 of FIG. 15).

The integrated circuit device 1600 may include one or more device layers 1604 disposed on the die substrate 1602. The device layer 1604 may include features of one or more transistors 1640 (e.g., metal oxide semiconductor field-effect transistors (MOSFETs)) formed on the die substrate 1602. The transistors 1640 may include, for example, one or more source and/or drain (S/D) regions 1620, a gate 1622 to control current flow between the S/D regions 1620, and one or more S/D contacts 1624 to route electrical signals to/from the S/D regions 1620. The transistors 1640 may include additional features not depicted for the sake of clarity, such as device isolation regions, gate contacts, and the like. The transistors 1640 are not limited to the type and configuration depicted in FIG. 16 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

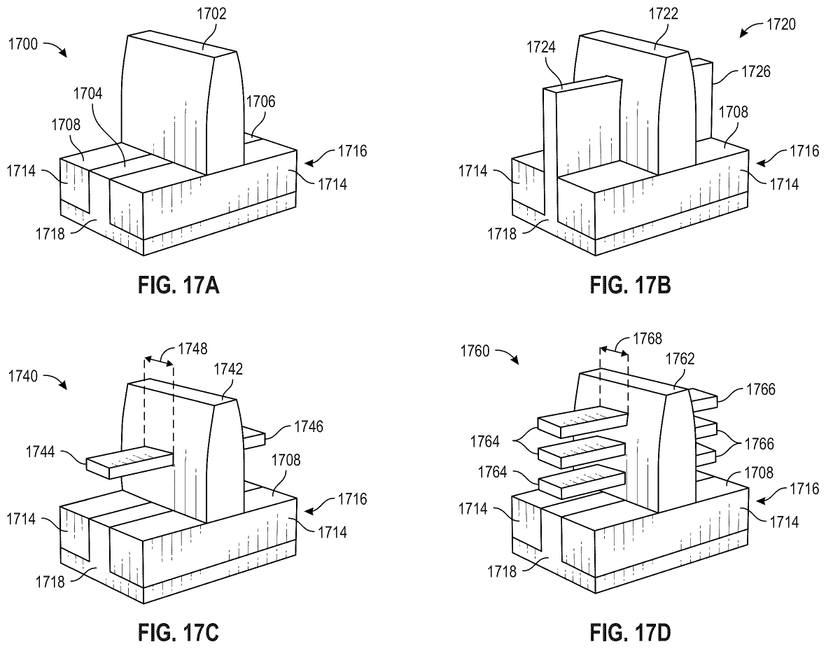

FIGS. 17A-17D are simplified perspective views of example planar, FinFET, gate-all-around, and stacked gate-all-around transistors. The transistors illustrated in FIGS. 17A-17D are formed on a substrate 1716 having a surface 1708. Isolation regions 1714 separate the source and drain regions of the transistors from other transistors and from a bulk region 1718 of the substrate 1716.

FIG. 17A is a perspective view of an example planar transistor 1700 comprising a gate 1702 that controls current flow between a source region 1704 and a drain region 1706. The transistor 1700 is planar in that the source region 1704 and the drain region 1706 are planar with respect to the substrate surface 1708.

FIG. 17B is a perspective view of an example FinFET transistor 1720 comprising a gate 1722 that controls current flow between a source region 1724 and a drain region 1726. The transistor 1720 is non-planar in that the source region 1724 and the drain region 1726 comprise “fins” that extend upwards from the substrate surface 1728. As the gate 1722 encompasses three sides of the semiconductor fin that extends from the source region 1724 to the drain region 1726, the transistor 1720 can be considered a tri-gate transistor. FIG. 17B illustrates one S/D fin extending through the gate 1722, but multiple S/D fins can extend through the gate of a FinFET transistor.

FIG. 17C is a perspective view of a gate-all-around (GAA) transistor 1740 comprising a gate 1742 that controls current flow between a source region 1744 and a drain region 1746. The transistor 1740 is non-planar in that the source region 1744 and the drain region 1746 are elevated from the substrate surface 1728.

FIG. 17D is a perspective view of a GAA transistor 1760 comprising a gate 1762 that controls current flow between multiple elevated source regions 1764 and multiple elevated drain regions 1766. The transistor 1760 is a stacked GAA transistor as the gate controls the flow of current between multiple elevated S/D regions stacked on top of each other. The transistors 1740 and 1760 are considered gate-all-around transistors as the gates encompass all sides of the semiconductor portions that extends from the source regions to the drain regions. The transistors 1740 and 1760 can alternatively be referred to as nanowire, nanosheet, or nanoribbon transistors depending on the width (e.g., widths 1748 and 1768 of transistors 1740 and 1760, respectively) of the semiconductor portions extending through the gate.

Returning to FIG. 16, a transistor 1640 may include a gate 1622 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1640 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1640 along the source-channel-drain direction, the gate electrode may consist of a U-shaped structure that includes a bottom portion substantially parallel to the surface of the die substrate 1602 and two sidewall portions that are substantially perpendicular to the top surface of the die substrate 1602. In other embodiments, at least one of the metal layers that form the gate electrode may simply be a planar layer that is substantially parallel to the top surface of the die substrate 1602 and does not include sidewall portions substantially perpendicular to the top surface of the die substrate 1602. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1620 may be formed within the die substrate 1602 adjacent to the gate 1622 of individual transistors 1640. The S/D regions 1620 may be formed using an implantation/diffusion process or an etching/deposition process, for example. In the former process, dopants such as boron, aluminum, antimony, phosphorous, or arsenic may be ion-implanted into the die substrate 1602 to form the S/D regions 1620. An annealing process that activates the dopants and causes them to diffuse farther into the die substrate 1602 may follow the ion-implantation process. In the latter process, the die substrate 1602 may first be etched to form recesses at the locations of the S/D regions 1620. An epitaxial deposition process may then be carried out to fill the recesses with material that is used to fabricate the S/D regions 1620. In some implementations, the S/D regions 1620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1620 may be formed using one or more alternate semiconductor materials such as germanium or a group III-V material or alloy. In further embodiments, one or more layers of metal and/or metal alloys may be used to form the S/D regions 1620.

Electrical signals, such as power and/or input/output (I/O) signals, may be routed to and/or from the devices (e.g., transistors 1640) of the device layer 1604 through one or more interconnect layers disposed on the device layer 1604 (illustrated in FIG. 16 as interconnect layers 1606-1610). For example, electrically conductive features of the device layer 1604 (e.g., the gate 1622 and the S/D contacts 1624) may be electrically coupled with the interconnect structures 1628 of the interconnect layers 1606-1610. The one or more interconnect layers 1606-1610 may form a metallization stack (also referred to as an “ILD stack”) 1619 of the integrated circuit device 1600.

The interconnect structures 1628 may be arranged within the interconnect layers 1606-1610 to route electrical signals according to a wide variety of designs; in particular, the arrangement is not limited to the particular configuration of interconnect structures 1628 depicted in FIG. 16. Although a particular number of interconnect layers 1606-1610 is depicted in FIG. 16, embodiments of the present disclosure include integrated circuit devices having more or fewer interconnect layers than depicted.

In some embodiments, the interconnect structures 1628 may include lines 1628a and/or vias 1628b filled with an electrically conductive material such as a metal. The lines 1628a may be arranged to route electrical signals in a direction of a plane that is substantially parallel with a surface of the die substrate 1602 upon which the device layer 1604 is formed. For example, the lines 1628a may route electrical signals in a direction in and out of the page and/or in a direction across the page. The vias 1628b may be arranged to route electrical signals in a direction of a plane that is substantially perpendicular to the surface of the die substrate 1602 upon which the device layer 1604 is formed. In some embodiments, the vias 1628b may electrically couple lines 1628a of different interconnect layers 1606-1610 together.

The interconnect layers 1606-1610 may include a dielectric material 1626 disposed between the interconnect structures 1628, as shown in FIG. 16. In some embodiments, dielectric material 1626 disposed between the interconnect structures 1628 in different ones of the interconnect layers 1606-1610 may have different compositions; in other embodiments, the composition of the dielectric material 1626 between different interconnect layers 1606-1610 may be the same. The device layer 1604 may include a dielectric material 1626 disposed between the transistors 1640 and a bottom layer of the metallization stack as well. The dielectric material 1626 included in the device layer 1604 may have a different composition than the dielectric material 1626 included in the interconnect layers 1606-1610; in other embodiments, the composition of the dielectric material 1626 in the device layer 1604 may be the same as a dielectric material 1626 included in any one of the interconnect layers 1606-1610.

A first interconnect layer 1606 (referred to as Metal 1 or “M1”) may be formed directly on the device layer 1604. In some embodiments, the first interconnect layer 1606 may include lines 1628a and/or vias 1628b, as shown. The lines 1628a of the first interconnect layer 1606 may be coupled with contacts (e.g., the S/D contacts 1624) of the device layer 1604. The vias 1628b of the first interconnect layer 1606 may be coupled with the lines 1628a of a second interconnect layer 1608.

The second interconnect layer 1608 (referred to as Metal 2 or “M2”) may be formed directly on the first interconnect layer 1606. In some embodiments, the second interconnect layer 1608 may include via 1628b to couple the lines 1628 of the second interconnect layer 1608 with the lines 1628a of a third interconnect layer 1610. Although the lines 1628a and the vias 1628b are structurally delineated with a line within individual interconnect layers for the sake of clarity, the lines 1628a and the vias 1628b may be structurally and/or materially contiguous (e.g., simultaneously filled during a dual-damascene process) in some embodiments.

The third interconnect layer 1610 (referred to as Metal 3 or “M3”) (and additional interconnect layers, as desired) may be formed in succession on the second interconnect layer 1608 according to similar techniques and configurations described in connection with the second interconnect layer 1608 or the first interconnect layer 1606. In some embodiments, the interconnect layers that are “higher up” in the metallization stack 1619 in the integrated circuit device 1600 (i.e., farther away from the device layer 1604) may be thicker that the interconnect layers that are lower in the metallization stack 1619, with lines 1628a and vias 1628b in the higher interconnect layers being thicker than those in the lower interconnect layers.

The integrated circuit device 1600 may include a solder resist material 1634 (e.g., polyimide or similar material) and one or more conductive contacts 1636 formed on the interconnect layers 1606-1610. In FIG. 16, the conductive contacts 1636 are illustrated as taking the form of bond pads. The conductive contacts 1636 may be electrically coupled with the interconnect structures 1628 and configured to route the electrical signals of the transistor(s) 1640 to external devices. For example, solder bonds may be formed on the one or more conductive contacts 1636 to mechanically and/or electrically couple an integrated circuit die including the integrated circuit device 1600 with another component (e.g., a printed circuit board). The integrated circuit device 1600 may include additional or alternate structures to route the electrical signals from the interconnect layers 1606-1610; for example, the conductive contacts 1636 may include other analogous features (e.g., posts) that route the electrical signals to external components.

In some embodiments in which the integrated circuit device 1600 is a double-sided die, the integrated circuit device 1600 may include another metallization stack (not shown) on the opposite side of the device layer(s) 1604. This metallization stack may include multiple interconnect layers as discussed above with reference to the interconnect layers 1606-1610, to provide conductive pathways (e.g., including conductive lines and vias) between the device layer(s) 1604 and additional conductive contacts (not shown) on the opposite side of the integrated circuit device 1600 from the conductive contacts 1636.

In other embodiments in which the integrated circuit device 1600 is a double-sided die, the integrated circuit device 1600 may include one or more through silicon vias (TSVs) through the die substrate 1602; these TSVs may make contact with the device layer(s) 1604, and may provide conductive pathways between the device layer(s) 1604 and additional conductive contacts (not shown) on the opposite side of the integrated circuit device 1600 from the conductive contacts 1636. In some embodiments, TSVs extending through the substrate can be used for routing power and ground signals from conductive contacts on the opposite side of the integrated circuit device 1600 from the conductive contacts 1636 to the transistors 1640 and any other components integrated into the die 1600, and the metallization stack 1619 can be used to route I/O signals from the conductive contacts 1636 to transistors 1640 and any other components integrated into the die 1600.

Multiple integrated circuit devices 1600 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

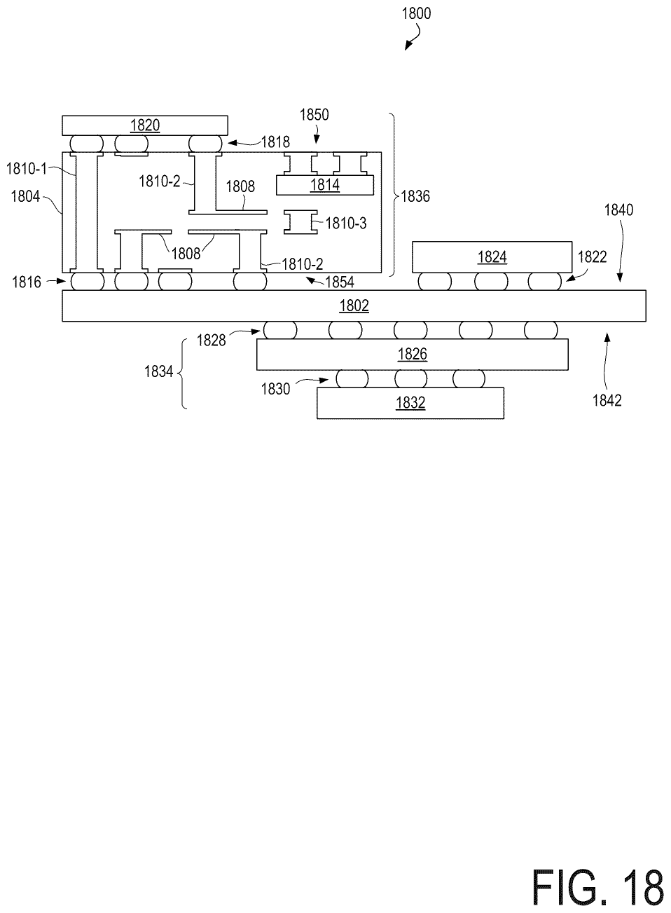

FIG. 18 is a cross-sectional side view of an integrated circuit device assembly 1800 that may include any of the integrated circuit packages 301 disclosed herein. In some embodiments, the integrated circuit device assembly 1800 may be an integrated circuit packages 301. The integrated circuit device assembly 1800 includes a number of components disposed on a circuit board 1802 (which may be a motherboard, system board, mainboard, etc.). The integrated circuit device assembly 1800 includes components disposed on a first face 1840 of the circuit board 1802 and an opposing second face 1842 of the circuit board 1802; generally, components may be disposed on one or both faces 1840 and 1842. Any of the integrated circuit components discussed below with reference to the integrated circuit device assembly 1800 may take the form of any suitable ones of the embodiments of the integrated circuit packages 301 disclosed herein.

In some embodiments, the circuit board 1802 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1802. In other embodiments, the circuit board 1802 may be a non-PCB substrate. In some embodiments the circuit board 1802 may be, for example, the circuit board 302. The integrated circuit device assembly 1800 illustrated in FIG. 18 includes a package-on-interposer structure 1836 coupled to the first face 1840 of the circuit board 1802 by coupling components 1816. The coupling components 1816 may electrically and mechanically couple the package-on-interposer structure 1836 to the circuit board 1802, and may include solder balls (as shown in FIG. 18), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1836 may include an integrated circuit component 1820 coupled to an interposer 1804 by coupling components 1818. The coupling components 1818 may take any suitable form for the application, such as the forms discussed above with reference to the coupling components 1816. Although a single integrated circuit component 1820 is shown in FIG. 18, multiple integrated circuit components may be coupled to the interposer 1804; indeed, additional interposers may be coupled to the interposer 1804. The interposer 1804 may provide an intervening substrate used to bridge the circuit board 1802 and the integrated circuit component 1820.

The integrated circuit component 1820 may be a packaged or unpacked integrated circuit product that includes one or more integrated circuit dies (e.g., the die 1502 of FIG. 15, the integrated circuit device 1600 of FIG. 16) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1820, a single monolithic integrated circuit die comprises solder bumps attached to contacts on the die. The solder bumps allow the die to be directly attached to the interposer 1804. The integrated circuit component 1820 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1820 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1820 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1820 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1804 may spread connections to a wider pitch or reroute a connection to a different connection. For example, the interposer 1804 may couple the integrated circuit component 1820 to a set of ball grid array (BGA) conductive contacts of the coupling components 1816 for coupling to the circuit board 1802. In the embodiment illustrated in FIG. 18, the integrated circuit component 1820 and the circuit board 1802 are attached to opposing sides of the interposer 1804; in other embodiments, the integrated circuit component 1820 and the circuit board 1802 may be attached to a same side of the interposer 1804. In some embodiments, three or more components may be interconnected by way of the interposer 1804.

In some embodiments, the interposer 1804 may be formed as a PCB, including multiple metal layers separated from one another by layers of dielectric material and interconnected by electrically conductive vias. In some embodiments, the interposer 1804 may be formed of an epoxy resin, a fiberglass-reinforced epoxy resin, an epoxy resin with inorganic fillers, a ceramic material, or a polymer material such as polyimide. In some embodiments, the interposer 1804 may be formed of alternate rigid or flexible materials that may include the same materials described above for use in a semiconductor substrate, such as silicon, germanium, and other group III-V and group IV materials. The interposer 1804 may include metal interconnects 1808 and vias 1810, including but not limited to through hole vias 1810-1 (that extend from a first face 1850 of the interposer 1804 to a second face 1854 of the interposer 1804), blind vias 1810-2 (that extend from the first or second faces 1850 or 1854 of the interposer 1804 to an internal metal layer), and buried vias 1810-3 (that connect internal metal layers).

In some embodiments, the interposer 1804 can comprise a silicon interposer. Through silicon vias (TSV) extending through the silicon interposer can connect connections on a first face of a silicon interposer to an opposing second face of the silicon interposer. In some embodiments, an interposer 1804 comprising a silicon interposer can further comprise one or more routing layers to route connections on a first face of the interposer 1804 to an opposing second face of the interposer 1804.

The interposer 1804 may further include embedded devices 1814, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1804. The package-on-interposer structure 1836 may take the form of any of the package-on-interposer structures known in the art. In embodiments where the interposer is a non-printed circuit board

The integrated circuit device assembly 1800 may include an integrated circuit component 1824 coupled to the first face 1840 of the circuit board 1802 by coupling components 1822. The coupling components 1822 may take the form of any of the embodiments discussed above with reference to the coupling components 1816, and the integrated circuit component 1824 may take the form of any of the embodiments discussed above with reference to the integrated circuit component 1820.

The integrated circuit device assembly 1800 illustrated in FIG. 18 includes a package-on-package structure 1834 coupled to the second face 1842 of the circuit board 1802 by coupling components 1828. The package-on-package structure 1834 may include an integrated circuit component 1826 and an integrated circuit component 1832 coupled together by coupling components 1830 such that the integrated circuit component 1826 is disposed between the circuit board 1802 and the integrated circuit component 1832. The coupling components 1828 and 1830 may take the form of any of the embodiments of the coupling components 1816 discussed above, and the integrated circuit components 1826 and 1832 may take the form of any of the embodiments of the integrated circuit component 1820 discussed above. The package-on-package structure 1834 may be configured in accordance with any of the package-on-package structures known in the art.

FIG. 19 is a block diagram of an example electrical device 1900 that may include one or more of the integrated circuit packages 301 disclosed herein. For example, any suitable ones of the components of the electrical device 1900 may include one or more of the integrated circuit device assemblies 1800, integrated circuit components 1820, integrated circuit devices 1600, or integrated circuit dies 1502 disclosed herein, and may be arranged in any of the integrated circuit packages 301 disclosed herein. A number of components are illustrated in FIG. 19 as included in the electrical device 1900, but any one or more of these components may be omitted or duplicated, as suitable for the application. In some embodiments, some or all of the components included in the electrical device 1900 may be attached to one or more motherboards mainboards, or system boards. In some embodiments, one or more of these components are fabricated onto a single system-on-a-chip (SoC) die.

Additionally, in various embodiments, the electrical device 1900 may not include one or more of the components illustrated in FIG. 19, but the electrical device 1900 may include interface circuitry for coupling to the one or more components. For example, the electrical device 1900 may not include a display device 1906, but may include display device interface circuitry (e.g., a connector and driver circuitry) to which a display device 1906 may be coupled. In another set of examples, the electrical device 1900 may not include an audio input device 1924 or an audio output device 1908, but may include audio input or output device interface circuitry (e.g., connectors and supporting circuitry) to which an audio input device 1924 or audio output device 1908 may be coupled.

The electrical device 1900 may include one or more processor units 1902 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1902 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1900 may include a memory 1904, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1904 may include memory that is located on the same integrated circuit die as the processor unit 1902. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1900 can comprise one or more processor units 1902 that are heterogeneous or asymmetric to another processor unit 1902 in the electrical device 1900. There can be a variety of differences between the processing units 1902 in a system in terms of a spectrum of metrics of merit including architectural, microarchitectural, thermal, power consumption characteristics, and the like. These differences can effectively manifest themselves as asymmetry and heterogeneity among the processor units 1902 in the electrical device 1900.

In some embodiments, the electrical device 1900 may include a communication component 1912 (e.g., one or more communication components). For example, the communication component 1912 can manage wireless communications for the transfer of data to and from the electrical device 1900. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1912 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1912 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1912 may operate in accordance with other wireless protocols in other embodiments. The electrical device 1900 may include an antenna 1922 to facilitate wireless communications and/or to receive other wireless communications (such as AM or FM radio transmissions).

In some embodiments, the communication component 1912 may manage wired communications, such as electrical, optical, or any other suitable communication protocols (e.g., IEEE 802.3 Ethernet standards). As noted above, the communication component 1912 may include multiple communication components. For instance, a first communication component 1912 may be dedicated to shorter-range wireless communications such as Wi-Fi or Bluetooth, and a second communication component 1912 may be dedicated to longer-range wireless communications such as global positioning system (GPS), EDGE, GPRS, CDMA, WiMAX, LTE, EV-DO, or others. In some embodiments, a first communication component 1912 may be dedicated to wireless communications, and a second communication component 1912 may be dedicated to wired communications.

The electrical device 1900 may include battery/power circuitry 1914. The battery/power circuitry 1914 may include one or more energy storage devices (e.g., batteries or capacitors) and/or circuitry for coupling components of the electrical device 1900 to an energy source separate from the electrical device 1900 (e.g., AC line power).

The electrical device 1900 may include a display device 1906 (or corresponding interface circuitry, as discussed above). The display device 1906 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1900 may include an audio output device 1908 (or corresponding interface circuitry, as discussed above). The audio output device 1908 may include any embedded or wired or wirelessly connected external device that generates an audible indicator, such speakers, headsets, or earbuds.

The electrical device 1900 may include an audio input device 1924 (or corresponding interface circuitry, as discussed above). The audio input device 1924 may include any embedded or wired or wirelessly connected device that generates a signal representative of a sound, such as microphones, microphone arrays, or digital instruments (e.g., instruments having a musical instrument digital interface (MIDI) output). The electrical device 1900 may include a Global Navigation Satellite System (GNSS) device 1918 (or corresponding interface circuitry, as discussed above), such as a Global Positioning System (GPS) device. The GNSS device 1918 may be in communication with a satellite-based system and may determine a geolocation of the electrical device 1900 based on information received from one or more GNSS satellites, as known in the art.

The electrical device 1900 may include an other output device 1910 (or corresponding interface circuitry, as discussed above). Examples of the other output device 1910 may include an audio codec, a video codec, a printer, a wired or wireless transmitter for providing information to other devices, or an additional storage device.

The electrical device 1900 may include an other input device 1920 (or corresponding interface circuitry, as discussed above). Examples of the other input device 1920 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1900 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1900 may be any other electronic device that processes data. In some embodiments, the electrical device 1900 may comprise multiple discrete physical components. Given the range of devices that the electrical device 1900 can be manifested as in various embodiments, in some embodiments, the electrical device 1900 can be referred to as a computing device or a computing system.

### Examples

Illustrative examples of the technologies disclosed herein are provided below. An embodiment of the technologies may include any one or more, and any combination of, the examples described below.

Example 1 includes an optical cable comprising one or more optical fibers; and an optical plug, the optical plug comprising a ferrule, wherein the one or more optical fibers terminate at the ferrule; a ferrule holder to hold the ferrule; and a housing to enclose the ferrule and the ferrule holder, wherein the ferrule can move relative to the ferrule holder and the housing, wherein the ferrule holder can move relative to the ferrule and the housing.

Example 2 includes the subject matter of Example 1, and wherein, when the optical cable is being mated with an optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

Example 3 includes the subject matter of any of Examples 1 and 2, and wherein the fine alignment aligns the ferrule to an interposer of the optical socket with a precision of less than one micrometer.

Example 4 includes the subject matter of any of Examples 1-3, and further including a retention mechanism comprising a spring clip, wherein the spring clip is to engage with an optical socket to secure the optical plug.

Example 5 includes the subject matter of any of Examples 1-4, and wherein the retention mechanism comprises a pull tab, wherein, when a pulling force is applied to the pull tab, the pull tab releases the spring clip from the optical socket.

Example 6 includes the subject matter of any of Examples 1-5, and wherein part of the retention mechanism is to press the ferrule against an interposer of the optical socket when the optical plug is mated with the optical socket.

Example 7 includes the subject matter of any of Examples 1-6, and wherein the optical plug has a height less than 3 millimeters and a width less than 8 millimeters.

Example 8 includes the subject matter of any of Examples 1-7, and further including a strain relief attached to the housing, wherein the one or more optical fibers can move relative to the strain relief.

Example 9 includes the subject matter of any of Examples 1-8, and further including one or more springs to press the ferrule against an interposer of an optical socket when the optical plug is mated with the optical socket.

Example 10 includes the subject matter of any of Examples 1-9, and wherein the one or more optical fibers comprise at least eight optical fibers.

Example 11 includes the subject matter of any of Examples 1-10, and wherein the housing comprises a slot orientation key.

Example 12 includes a system comprising the optical cable of Example 1, the system further comprising an integrated circuit package comprising an optical socket, wherein, when the optical cable is being mated with the optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

Example 13 includes a system comprising an integrated circuit package comprising an optical socket; and an optical cable, the optical cable comprising a ferrule; one or more optical fibers, wherein the one or more optical fibers terminate at the ferrule; a ferrule holder to hold the ferrule; and a housing to enclose the ferrule and the ferrule holder, wherein, when the optical cable is being mated with the optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

Example 14 includes the subject matter of Example 13, and wherein the optical socket comprises a glass interposer, wherein one or more waveguides are defined in the glass interposer, wherein, when the optical cable is mated with the optical socket, the one or more optical fibers are optically coupled to the one or more waveguides.

Example 15 includes the subject matter of any of Examples 13 and 14, and wherein the integrated circuit package comprises one or more photonic integrated circuit (PIC) dies, wherein the one or more waveguides of the glass interposer are to carry light between the optical cable and the one or more PIC dies.

Example 16 includes the subject matter of any of Examples 13-15, and wherein the integrated circuit package comprises one or more electronic integrated circuit (EIC) dies, wherein the one or more EIC dies are electrically coupled to the one or more PIC dies.

Example 17 includes the subject matter of any of Examples 13-16, and wherein the integrated circuit package comprises an integrated heat spreader adjacent the one or more EIC dies, wherein at least part of the optical socket is defined in the integrated heat spreader.

Example 18 includes the subject matter of any of Examples 13-17, and wherein a rib for an orientation key of the optical socket is defined in the integrated heat spreader.

Example 19 includes the subject matter of any of Examples 13-18, and wherein the integrated circuit package comprises a substrate and a receptacle component attached to the substrate, wherein the receptacle component comprises the optical socket.

Example 20 includes the subject matter of any of Examples 13-19, and wherein the integrated circuit package comprises a substrate, wherein at least part of the optical socket is defined in the substrate.

Example 21 includes the subject matter of any of Examples 13-20, and wherein a rib for an orientation key of the optical socket is defined in the substrate.

Example 22 includes the subject matter of any of Examples 13-21, and wherein the ferrule holder comprises one or more alignment features extending from a body of the ferrule holder, wherein the one or more alignment features are to mate with corresponding alignment features of the optical socket.

Example 23 includes the subject matter of any of Examples 13-22, and wherein the optical cable further comprises one or more wire clips, wherein the one or more wire clips are to position the ferrule holder relative to the optical socket by mating with one or more alignment features of the optical socket.

Example 24 includes the subject matter of any of Examples 13-23, and wherein the ferrule comprises one or more pins and a protrusion, wherein the one or more optical fibers terminate at the protrusion, wherein the optical socket comprises an interposer, wherein the interposer comprises one or more holes and a cut-out feature, wherein the one or more pins of the ferrule are to mate with the one or more holes, wherein the protrusion of the ferrule is to mate with the cut-out feature of the optical socket.

Example 25 includes the subject matter of any of Examples 13-24, and wherein the ferrule comprises one or more pins and a protrusion, wherein the one or more optical fibers terminate at the protrusion, wherein the optical socket comprises an interposer, wherein the interposer comprises one or more V-grooves and a cut-out feature, wherein the one or more pins of the ferrule are to mate with the one or more V-grooves, wherein the protrusion of the ferrule is to mate with the cut-out feature of the optical socket.

Example 26 includes the subject matter of any of Examples 13-25, and wherein the ferrule comprises a protrusion and one or more cut-out features defined in one or more sidewalls of the protrusion, wherein the one or more optical fibers terminate at the protrusion, wherein the optical socket comprises an interposer, wherein the interposer comprises a cut-out feature and one or more protrusions extending from one or more sidewalls of the cut-out feature, wherein the protrusion of the ferrule is to mate with the cut-out feature of the optical socket, wherein the one or more protrusions extending from the one or more sidewall of the cut-out feature of the interposer are to mate with the one or more cut-out features defined in the one or more sidewalls of the protrusion.

Example 27 includes an optical cable comprising one or more optical fibers; and an optical plug, the optical plug comprising means for aligning the one or more optical fibers to an optical socket in a plurality of stages.

Example 28 includes the subject matter of Example 27, and wherein the means for aligning the one or more optical fibers to the optical socket in the plurality of stages comprises a housing, a ferrule holder, and a ferrule.

Example 29 includes the subject matter of any of Examples 27 and 28, and wherein, when the optical cable is being mated with the optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

Example 30 includes the subject matter of any of Examples 27-29, and wherein the means for aligning the one or more optical fibers to the optical socket in the plurality of stages is able to align the one or more optical fibers within the optical socket with a precision of less than one micrometer.

Example 31 includes the subject matter of any of Examples 27-30, and wherein the means for aligning the one or more optical fibers to the optical socket aligns a ferrule to an interposer of the optical socket with a precision of less than one micrometer.

Example 32 includes the subject matter of any of Examples 27-31, and further including a retention mechanism comprising a spring clip, wherein the spring clip is to engage with the optical socket to secure the optical plug.

Example 33 includes the subject matter of any of Examples 27-32, and wherein the retention mechanism comprises a pull tab, wherein, when a pulling force is applied to the pull tab, the pull tab releases the spring clip from the optical socket.

Example 34 includes the subject matter of any of Examples 27-33, and wherein part of the retention mechanism is to press a ferrule against an interposer of the optical socket when the optical plug is mated with the optical socket.

Example 35 includes the subject matter of any of Examples 27-34, and wherein the optical plug has a height less than 3 millimeters and a width less than 8 millimeters.

Example 36 includes the subject matter of any of Examples 27-35, and further including a strain relief attached to a housing of the optical plug, wherein the one or more optical fibers can move relative to the strain relief.

Example 37 includes the subject matter of any of Examples 27-36, and further including one or more springs to press a ferrule against an interposer of the optical socket when the optical plug is mated with the optical socket.

Example 38 includes the subject matter of any of Examples 27-37, and wherein the one or more optical fibers comprise at least eight optical fibers.

Example 39 includes the subject matter of any of Examples 27-38, and wherein the optical plug comprises a housing that comprises a slot orientation key.

Example 40 includes a method comprising forming an ferrule with one or more alignment features using laser machining; connecting one or more optical fibers to the ferrule; assembling the ferrule and a ferrule holder into a housing of an optical plug; forming an optical socket with one or more alignment features corresponding to the one or more alignment features of the ferrule; assembling an integrated circuit package with the optical socket; and plugging the optical plug into the optical socket.

Example 41 includes the subject matter of Example 40, and wherein, when the optical plug is being mated with the optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

Example 42 includes the subject matter of any of Examples 40 and 41, and wherein the fine alignment aligns the ferrule to an interposer of the optical socket with a precision of less than one micrometer.

Example 43 includes the subject matter of any of Examples 40-42, and further including assembling a retention mechanism into the optical plug, the retention mechanism comprising a spring clip, wherein the spring clip is to engage with the optical socket to secure the optical plug.

Example 44 includes the subject matter of any of Examples 40-43, and wherein the retention mechanism comprises a pull tab, wherein, when a pulling force is applied to the pull tab, the pull tab releases the spring clip from the optical socket.

Example 45 includes the subject matter of any of Examples 40-44, and wherein part of the retention mechanism is to press a ferrule against an interposer of the optical socket when the optical plug is mated with the optical socket.

Example 46 includes the subject matter of any of Examples 40-45, and wherein the optical plug has a height less than 3 millimeters and a width less than 8 millimeters.

Example 47 includes the subject matter of any of Examples 40-46, and further including assembling a strain relief into the optical plug, the strain relief attached to the housing, wherein the one or more optical fibers can move relative to the strain relief.

Example 48 includes the subject matter of any of Examples 40-47, and further including assembling one or more springs into the optical plug, the one or more springs to press the ferrule against an interposer of the optical socket when the optical plug is mated with the optical socket.

Example 49 includes the subject matter of any of Examples 40-48, and wherein the one or more optical fibers comprise at least eight optical fibers.

Example 50 includes the subject matter of any of Examples 40-49, and wherein the housing comprises a slot orientation key.

1. An optical cable comprising:
one or more optical fibers; and
an optical plug, the optical plug comprising:
a ferrule, wherein the one or more optical fibers terminate at the ferrule;
a ferrule holder to hold the ferrule; and
a housing to enclose the ferrule and the ferrule holder,
wherein the ferrule can move relative to the ferrule holder and the housing, wherein the ferrule holder can move relative to the ferrule and the housing.

2. The optical cable of claim 1, wherein, when the optical cable is being mated with an optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

3. The optical cable of claim 2, wherein the fine alignment aligns the ferrule to an interposer of the optical socket with a precision of less than one micrometer.

4. The optical cable of claim 1, further comprising a retention mechanism comprising a spring clip, wherein the spring clip is to engage with an optical socket to secure the optical plug.

5. The optical cable of claim 4, wherein the retention mechanism comprises a pull tab, wherein, when a pulling force is applied to the pull tab, the pull tab releases the spring clip from the optical socket.

6. The optical cable of claim 4, wherein part of the retention mechanism is to press the ferrule against an interposer of the optical socket when the optical plug is mated with the optical socket.

7. The optical cable of claim 1, wherein the optical plug has a height less than 3 millimeters and a width less than 8 millimeters.

8. The optical cable of claim 1, further comprising a strain relief attached to the housing, wherein the one or more optical fibers can move relative to the strain relief.

9. The optical cable of claim 1, further comprising one or more springs to press the ferrule against an interposer of an optical socket when the optical plug is mated with the optical socket.

10. The optical cable of claim 1, wherein the one or more optical fibers comprise at least eight optical fibers.

11. The optical cable of claim 1, wherein the housing comprises a slot orientation key.

12. A system comprising the optical cable of claim 1, the system further comprising an integrated circuit package comprising an optical socket,
wherein, when the optical cable is being mated with the optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

13. A system comprising:
an integrated circuit package comprising an optical socket; and
an optical cable, the optical cable comprising:
a ferrule;
one or more optical fibers, wherein the one or more optical fibers terminate at the ferrule;
a ferrule holder to hold the ferrule; and
a housing to enclose the ferrule and the ferrule holder,
wherein, when the optical cable is being mated with the optical socket, the housing provides coarse alignment to the optical socket, the ferrule holder provides intermediate alignment to the optical socket, and the ferrule provides fine alignment to the optical socket, wherein the fine alignment is more precise than the intermediate alignment, wherein the intermediate alignment is more precise than the coarse alignment.

14. The system of claim 13, wherein the optical socket comprises a glass interposer,
wherein one or more waveguides are defined in the glass interposer,
wherein, when the optical cable is mated with the optical socket, the one or more optical fibers are optically coupled to the one or more waveguides.

15. The system of claim 14, wherein the integrated circuit package comprises one or more photonic integrated circuit (PIC) dies,
wherein the one or more waveguides of the glass interposer are to carry light between the optical cable and the one or more PIC dies.

16. The system of claim 14, wherein the integrated circuit package comprises one or more electronic integrated circuit (EIC) dies, wherein the one or more EIC dies are electrically coupled to the one or more PIC dies.

17. The system of claim 16, wherein the integrated circuit package comprises an integrated heat spreader adjacent the one or more EIC dies, wherein at least part of the optical socket is defined in the integrated heat spreader.

18. The system of claim 17, wherein a rib for an orientation key of the optical socket is defined in the integrated heat spreader.

19. The system of claim 14, wherein the integrated circuit package comprises a substrate and a receptacle component attached to the substrate, wherein the receptacle component comprises the optical socket.

20. The system of claim 13, wherein the integrated circuit package comprises a substrate, wherein at least part of the optical socket is defined in the substrate.

21. The system of claim 20, wherein a rib for an orientation key of the optical socket is defined in the substrate.

22. An optical cable comprising:
one or more optical fibers; and
an optical plug, the optical plug comprising means for aligning the one or more optical fibers to an optical socket in a plurality of stages.

23. The optical cable of claim 22, wherein the means for aligning the one or more optical fibers to the optical socket in the plurality of stages comprises a housing, a ferrule holder, and a ferrule.

24. The optical cable of claim 22, wherein the means for aligning the one or more optical fibers to the optical socket in the plurality of stages is able to align the one or more optical fibers within the optical socket with a precision of less than one micrometer.

25. The optical cable of claim 24, wherein the means for aligning the one or more optical fibers to the optical socket aligns a ferrule to an interposer of the optical socket with a precision of less than one micrometer.
